(19) United States
(12) Patent Application Publication
(10) Pub. No.: US 2004/0150858 A1
(43) Pub. Date: Aug. 5, 2004

(54) Method, apparatus and system for image data correction

(76) Inventors: Tomasz J. Cholewo, Lexington, KY (US); Brian W. Damon, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/732,142

(22) Filed: Dec. 10, 2003

Related U.S. Application Data
(60) Provisional application No. 60/444,234, filed on Jan. 31, 2003.

(51) Int. Cl. H04N 1/405; H04N 1/52

(52) U.S. Cl. 358/3.06; 358/406; 358/504; 358/534

(57) ABSTRACT

Image data is corrected in a device or system using multiple halftones by predicting a second tone transfer curve corresponding to a second halftone based on a first tone transfer curve corresponding to a first halftone. First and second tone transfer curve compensate for application of the first halftone and the second halftone, respectively, to image data. The first tone transfer curve is determined by measuring image data halftoned with the first halftone and developing a first tone transfer curve that linearizes the measured image data. To produce the second tone transfer response curve, measured values of image data halftoned with the second halftone are estimated based on a predetermined relationship between the measured image data that is halftoned with the first halftone and image data that is halftoned with the second halftone. The second tone transfer curve is then developed as the curve that linearizes the estimated measured values of image data halftoned with the second halftone.

### CROSS-REFERENCE TO RELATED APPLICATION

This applications claims priority to U.S. Provisional Application No. 60/444,234, filed Jan. 31, 2003, and herein incorporated by reference.

### BACKGROUND

The present invention is directed to a method, apparatus and system for correcting image data.

Imaging devices, such as printers and displays, are typically capable of outputting a certain number of colors at each location output. This capability is referred to as the device's “bit-depth”.

Halftoning of image data is required whenever the output image bit-depth is smaller than the input image data bit-depth. This situation occurs most often in devices such as printers in which there are most commonly only two possibilities at each physical location: leave paper unprinted or put toner/ink at location.

As an example, consider a typical multifunction device (MFD) that includes a scanner and a printer. The scanner can typically create image scans in various formats, such as 24 bit RGB, 32 bit CMYK, 8 bit gray, or binary CMYK. The image with multiple levels of gray or color (i.e., a continuous tone image) is rendered from the scanner to the printer in a half toning process.

To perform optimally, a MFD may require that the scanner generate binary monochrome or color data. However, the binary data must include sufficient compensation to enable the printer to meet standard copy quality requirements. This function is usually accomplished by building in static color tables or transfer functions for the scanner and the printer and further modifying the scanned image. Accordingly, autonomous scanning stations may have standard color profiles that a user may select. In addition, vendors may provide software and/or hardware solutions that serve to calibrate the colors and/or gray shading of a scanned image.

Whenever a printer is relatively stable over life, pre-built, static color tables or transfer functions will be sufficient to allow consistent color or monochrome copies. Many color laser print mechanisms contain means that allow the printer to operate with little deviation, such that static RGB to CMYK color tables are sufficient to maintain color quality. The means by which this is done is often proprietary and essentially hidden from the user unless the printer is used in an a typical fashion.

The printing of binary monochrome or color data can be considered an a typical printing function since it bypasses the color correction performed for the printer's halftone response. If a printer has the means to dynamically correct the printer halftone response based on, e.g., data from an optical sensor, and does so internally for image data and requested color prior to halftoning, then an MFD solution that needs to print binary monochrome and color data has to somehow account for the variations in operating point and halftone response, caused by conversion of the scanned image data into a format suitable for the printer, to maintain image quality.

In addition to multifunction scanning/printing devices, halftoning is also often needed for outputting image data to computer displays, such as cathode ray tube (CRT) or liquid crystal display (LCD) monitors.

Most halftoning methods are spatially based, i.e., they use the human visual system spatial averaging properties in which a neighborhood of bi-level pixels are averaged to provide a sensation of intermediate color level.

Another class of halftoning method, unique to display and impossible to reproduce in printers, uses time-domain halftoning. Binary values at each pixel change in time in an appropriate ratio to produce the intermediate level sensation image data that may be rendered between input devices, such as a web browser, and output devices, such as a display. Each of these devices may require a different halftone response. Ideally, a solution for image correction would be applicable to any input/output device.

There is thus a need for a technique for dynamically correcting image data that is applicable to any input/output device.

### SUMMARY

According to exemplary embodiments, a method, apparatus and system provide dynamic image data correction.

According to one embodiment, a first tone transfer curve corresponding to a first halftone is determined. A second tone transfer curve corresponding to a second halftone is determined, based on the determined first tone transfer curve. The first tone transfer curve compensates for output variations caused by application of the first halftone to image data, and the second tone transfer curve compensates for output variations caused by application of the second halftone data to the image data.

According to one embodiment, the first halftone and the second halftone may be applied to account for variations in image data processed by and output from a multifunction device including two imaging devices, such as a printer-scanner combination. According to another embodiment, the first halftone and the second halftone may be applied for image data processed by and output from a single imaging device, such as a printer.

According to one embodiment, the first tone transfer curve is determined by measuring image data halftoned with the first halftone and developing a first tone transfer curve that linearizes the measured image data. The second tone transfer response curve is predicted by estimating measured values of image data halftoned with the second halftone, based on a predetermined relationship between the measured image data that is halftoned with the first halftone and image data that is halftoned with the second halftone, and developing the second transfer curve as the curve that linearizes the estimated measured values of image data halftoned with the second halftone.

### BRIEF DESCRIPTION OF THE DRAWINGS

The accompanying drawings illustrate exemplary embodiments of the invention, and together with the description, serve to explain the principles of the invention.

FIG. 1 is a flow chart illustrating steps of an exemplary process for image data correction;

FIGS. 2A-2C graphically illustrates how a first halftone response is adjusted according to exemplary embodiments;

FIGS. 3A-3C graphically illustrate how a second halftone response is related to the first halftone response to determine how to adjust the second halftone response according to exemplary embodiments;

FIG. 4 illustrates a detailed process for dynamically correcting image data in a multifunction device according to an exemplary embodiment; and

FIG. 5 is a block diagram illustrating an exemplary implementation of a system for image data correction in a multifunction device.

### DETAILED DESCRIPTION

According to exemplary embodiments, dynamic image data correction is provided for image data processed in any input/output device, e.g., a scanner, a printer, and/or a display, using different halftones. For illustrative purposes, much of the description below relates to image data color correction in a multifunction device including a scanner/printer. It will be appreciated, however, that the invention is not limited to this implementation. Rather, the image data correction may be applied to image data input to and/or output from any imaging device.

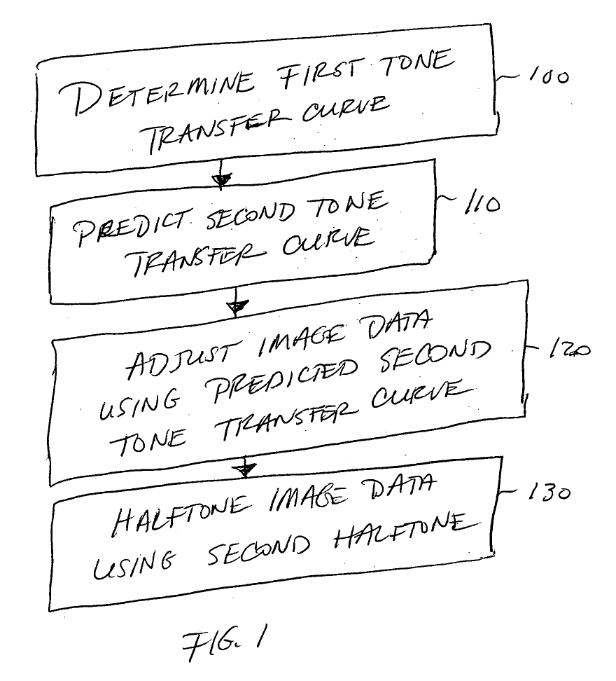

FIG. 1 illustrates exemplary steps of a process for image data correction in one or more imaging devices using different halftones according to an exemplary embodiment. At step 100, a first tone transfer curve is determined. The tone transfer curve is applied to the image data to compensate for output variations caused by application of a first halftone to the image data. Determination of the first transfer curve may be performed by, e.g., measuring in advance image data halftoned with the first halftone and then forming a transfer function that linearizes this halftoned image data.

Next, at step 110, a second tone transfer curve is predicted. This prediction may be based on a predetermined relationship between the first tone transfer curve and a second tone transfer curve related to a second halftone. To establish this relationship, a sampling of data from devices applying various second halftones may be taken, and the sampled data from each device may be linearized to produce second tone transfer curves. Then, the second tone transfer curves may be mapped to the first tone transfer curves for any combination of known first halftones and second halftones.

According to one embodiment, at step 120, the image data is adjusted using the predicted second tone transfer curve. This adjustment compensates for output variations caused by applying the second halftone to the image data. At step 130, the second halftone is then applied to the adjusted image data.

Although not shown explicitly as steps in the process of FIG. 1, it will be appreciated that the first tone transfer curve and the first halftone may be applied to the image data at any point in the image data correction process.

Also, as an alternative to steps 120 and 130, the second halftone may be adjusted using the predicted second tone transfer curve, and the adjusted second halftone may then be applied to the image data.

According to one embodiment, dynamic data correction is provided in a multifunction device including a scanner and a printer. In this type of device, the “first halftone” may be considered the halftone typically applied to account for variations caused by the printer to produce data suitable for output from the printer. The “second halftone” may be considered the halftone applied to account for variations caused by image processing in converting the scanned image data into the proper format for the printer, to produce data suitable for output from the printer.

This data correction may take advantage of measurements typically made as part of a printer's calibration process.

A typical color printer utilizes an optical sensor that is used to adjust the operating point and colorant transfer functions in response to environmental changes. The printer uses several events to determine when it must calibrate. These include fuser temperature, number of pages printed, elapsed time since the last calibration, etc.

A typical calibration process involves printing patches of halftoned color on the transfer belt, not delivering this image to paper, but measuring the result with an optical sensor. The operating point for the printer is adjusted based on empirically derived equations that are used to convert the measured reflectance data to equivalent L*a*b* color space estimates. Using the converted data, the printer derives the correct adjustment for any input color value, the result being that printing of a color using a printer's halftones results in nearly the equivalent of the color being printed upon a media. This solution maintains consistent colors over a variety of printers, operating environments, cartridge and printer life when monochrome or color data is halftoned by the printer.

According to an exemplary embodiment, a relationship may be determined between the optical sensor data response for the built-in printer halftones and a selected halftoning method for the multifunction device. For this purpose, a data sampling is obtained from a group of printers of the sensor data and a selected halftone method. From this data, a correlation is established by determining the relationship between a set of toner patch sensor (TPS) variables and a corresponding set of points on a printer's response to error diffusion/halftoning.

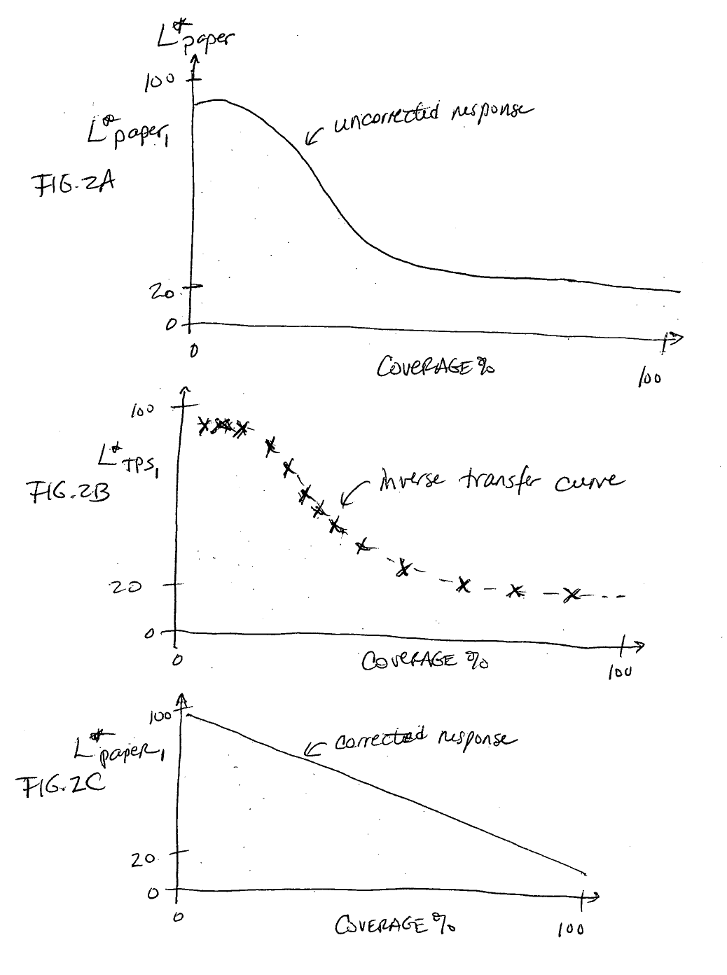

FIGS. 2A-2C graphically illustrate an internal printer calibration process that uses TPS measurements to make a halftone response linear on paper. In FIG. 2A, the intensity of a particular colorant L* on paper (L*ₚₐₚₑᵣ₁) is graphed for coverage values from 0 to 100% coverage, with no halftone correction. The curve in FIG. 2A represents a halftone response with no correction. To obtain the curve shown in FIG. 2A without actually printing, TPS measurements may be made, and the resulting intensity L*_{TPS1} may be plotted at different coverage values, as shown in FIG. 2B.

The plotted L*_{TPS1} data points shown in FIG. 2B roughly describe the shape of the uncorrected halftone response curve shown in FIG. 2A. Thus, to produce a linear response, the inverse of the curve in FIG. 2B is determined. This inverse curve is applied to the input image data to produce a corrected linear response, as shown in FIG. 2C.

The line shown in FIG. 2C represents the intensity of a particular colorant L* on paper for coverage values from 0 to 100%, with the halftone correction applied.

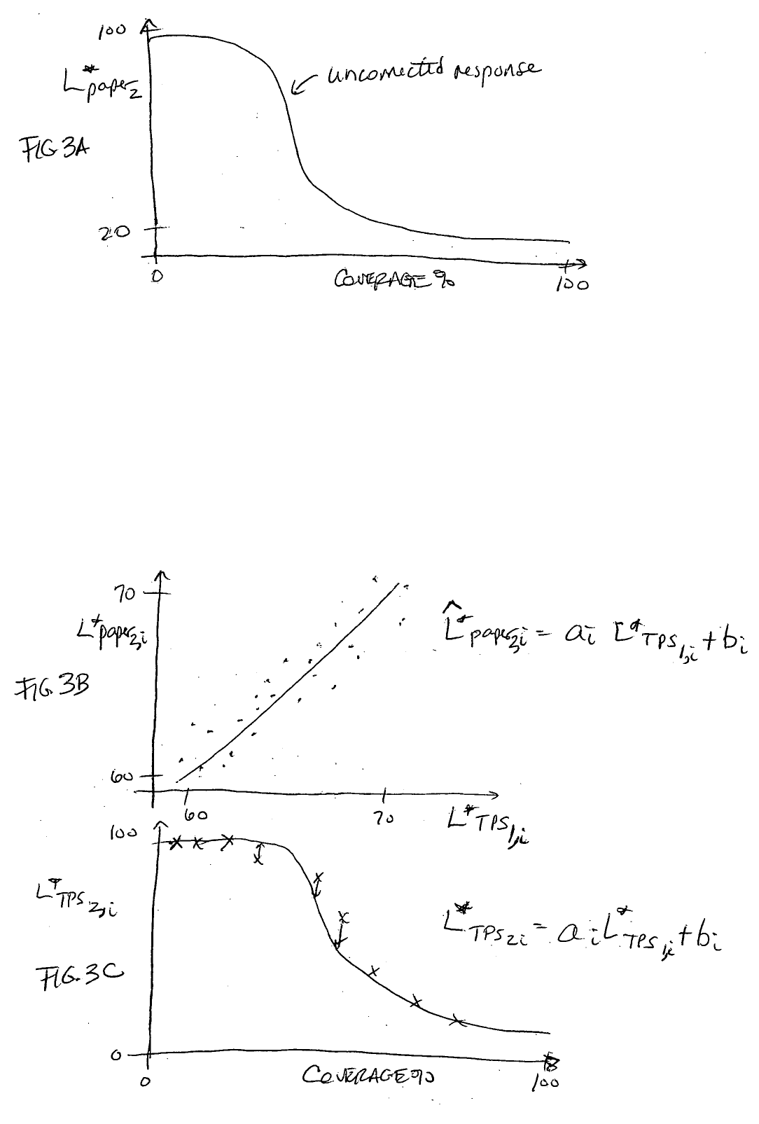

According to exemplary embodiments, the inverse transfer curve used for correcting one halftone can be used to establish a new curve that will approximately correct another halftone. For ease of explanation, these halftones may be referred to as halftone 1 and halftone 2. Following this nomenclature, an uncorrected response to halftone 1 is represented in FIG. 2A, and an uncorrected response to the application of halftone 2 is shown in FIG. 3A.

To map halftone 1 to halftone 2, multiples sets of TPS measurements may be taken at different coverage values. For a multifunction device, these measurements may be during the various points in the life span of differing printing cartridges located in diverse printers in an assortment of environments. Then, a single nominal coverage value “i” is concentrated on, and for this coverage value, values of intensity L*_{TPS1,j} are plotted against values of intensity L*_{paper2,j . . . .}

In FIG. 3B, L*_{Tps1,j} is shown on the x axis, and L*_{paper2,i} is shown on the y axis. Each point on this graph originates from a different set of data. If there is a predictive relationship between these points, it will appear as an approximately linear “cloud” of points. A linear fit may then be created to describe this relationship. This is done for each of the coverage values (points) “i” to result in linear equations that indicate how to convert each of the L*_{TPs1,i} values to L*ₚₐₚₑᵣ₂ᵢ values on the halftone 2 response curve.

To further understand how a second halftone response curve can be obtained from a first halftone response curve, consider a single data set collected at a specific time during a calibration state relating the TPS data to the halftone 2 measurement on paper at different coverage values. This relation may be shown as L*_{Tps1,j}->L*_{paper2,i} where “i” indicates the coverage value.

Assume that data sets are collected at 13 different coverage values. This data may be represented as follows:

L*_{TPS1,1}->L*_{paper2,1}

L*_{TPS1,2}->L*_{paper2,2}

L*_{TPS1,3}->L*_{paper2,3}

L*_{TPS1,4}->L*_{paper2,4}

L*_{TPS1,5}->L*_{paper2,5}

L*_{TPS1,6}->L*_{paper2,6}

L*_{TPS1,7}->L*_{paper2,7}

L*_{TPs1,8}->L*_{paper2,8}

L*_{TPS1,9}->L*_{paper2,9}

L*_{TPs1,10}->L*_{paper2,10}

L*_{TPs1,11}->L*_{paper2,11}

L*_{TPS1,12}->L*_{paper2,12}

L*_{TPS1,13}->L*_{paper2,13}

Now, consider that multiple sets of these pairs of data are collected at various times in a printer's life. This may be represented by the data shown in Table 1.

TABLE I

| Time 1 | Time 2 | Time 3 |
|---|---|---|
| L*_{TPS1,1} −> L*_{paper2,1} | L*_{TPS1,1} −> L*_{paper2,1} | L*_{TPS1,1} −> L*_{paper2,1} |
| L*_{TPS1,2} −> L*_{paper2,2} | L*_{TPS1,2} −> L*_{paper2,2} | L*_{TPS1,2} −> L*_{paper2,2} |
| L*_{TPS1,3} −> L*_{paper2,3} | L*_{TPS1,3} −> L*_{paper2,3} | L*_{TPS1,3} −> L*_{paper2,3} |
| L*_{TPS1,4} −> L*_{paper2,4} | L*_{TPS1,4} −> L*_{paper2,4} | L*_{TPS1,4} −> L*_{paper2,4} |
| L*_{TPS1,5} −> L*_{paper2,5} | L*_{TPS1,5} −> L*_{paper2,5} | L*_{TPS1,5} −> L*_{paper2,5} |
| L*_{TPS1,6} −> L*_{paper2,6} | L*_{TPS1,6} −> L*_{paper2,6} | L*_{TPS1,6} −> L*_{paper2,6} |
| L*_{TPS1,7} −> L*_{paper2,7} | L*_{TPS1,7} −> L*_{paper2,7} | L*_{TPS1,7} −> L*_{paper2,7} |
| L*_{TPS1,8} −> L*_{paper2,8} | L*_{TPS1,8} −> L*_{paper2,8} | L*_{TPS1,8} −> L*_{paper2,8} |
| L*_{TPS1,9} −> L*_{paper2,9} | L*_{TPS1,9} −> L*_{paper2,9} | L*_{TPS1,9} −> L*_{paper2,9} |
| L*_{TPS1,10} −> L*_{paper2,10} | L*_{TPS1,10} −> | L*_{TPS1,10} −> |
| | L*_{paper2,10} | L*_{paper2,10} |
| L*_{TPS1,11} −> L*_{paper2,11} | L*_{TPS1,11} −> | L*_{TPS1,11} −> |
| | L*_{paper2,11} | L*_{paper2,11} |
| L*_{TPS1,12} −> L*_{paper2,12} | L*_{TPS1,12} −> | L*_{TPS1,12} −> |
| | L*_{paper2,12} | L*_{paper2,12} |
| L*_{TPS1,13} −> L*_{paper2,13} | L*_{TPS1,13} −> | L*_{TPS1,13} −> |
| | L*_{paper2,13} | L*_{paper2,13} |

The relationship between the first halftone response curve and the second halftone response curve is then obtained by taking data at a single coverage value, e.g., all the points for coverage value “i”, and plotting them as different points on a scatter plot, as shown, e.g., in FIG. 3B. This relationship, which may be expressed in the form of an equation L*_{paper2,i}=aᵢL_{TPS1,1}+bᵢ this may then be used to predict the halftone 2 response curve.

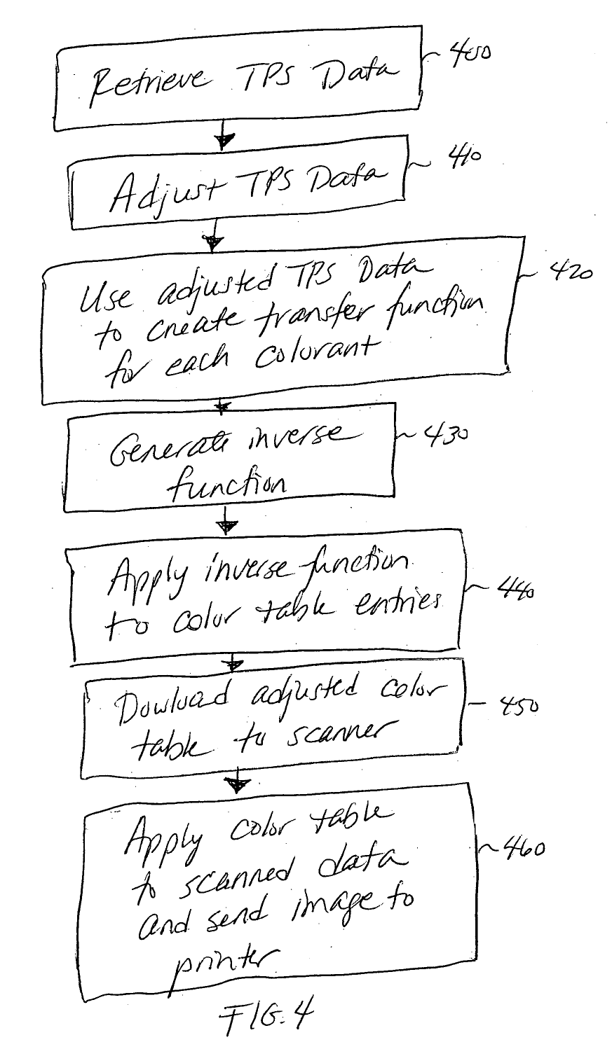

For illustrative purposes, FIG. 4 shows a detailed process for dynamic image correction in a multifunction device including a scanner and a printer, according to an exemplary embodiment. Image data correction may be performed, e.g., upon calibration of the multifunction device. At step 400, the TPS data representing the tone transfer curve applied by the scanner is retrieved. The data may be directly measured, e.g., if the printer is calibrating. If the printer is not calibrating or if a successful calibration has completed, the scanner reads the measured resultant reflectance value from the last successful printer calibration function. Notification of the calibration status may be provided to the scanner either automatically or upon query from the scanner. The measured reflectance values provide an indication of the tone response curve applied by the scanner to the scanned data.

Steps 410-440 are used for predicting a tone transfer curve for compensating for the second halftone applied by the printer. At step 410, the TPS data is adjusted to approximate the expected error diffusion transfer function (or halftoning method of the printer, which is different than the method used to halftone the scanned image). This involves adjusting the measured resultant reflectance value to approximate an expected error diffusion transfer function using a maximum of three sets of linear equations. The TPS data is adjusted to approximate the expected error diffusion transfer function. In this step, linear equations of the form “ax+b” may be used, wherein “x” is the difference between current calibration TPS data and the basis TPS data for the set of linear equations that are being utilized. The adjusted resultant reflectance value or TPS data is used to create a transfer function for each colorant by fitting curves to, e.g., a thirteen point variable plot and generating an inverse function from the result. At step 430, an inverse function of the result is calculated. At step 440, the inverse function is applied to a set of color table entries. Then, at step 450, the adjusted color table entries are downloaded to the scanner. At step 460, the scanner applies the color table to the scanned data to create a binary monochrome or CMYK image prior to transmitting the image to the printer at step 460. Thus, data correction may be performed in the scanner for compensating for output variations caused by application of the printer halftone. This maximizes efficiency of the overall system.

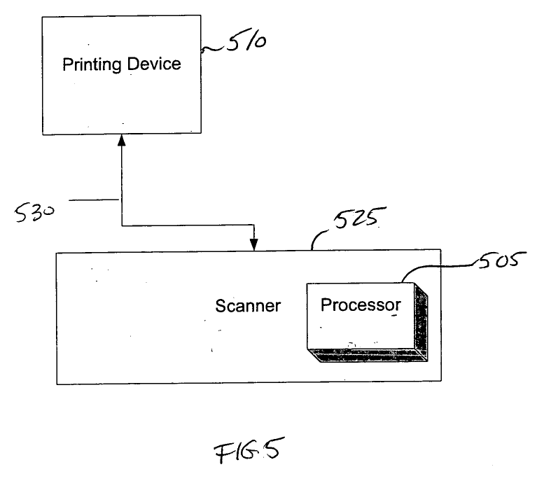

FIG. 5 is a block illustration of an exemplary system for providing dynamic color correction in a multifunction device. The system includes a first device, such as a printer 510, and a second device, such as a scanner 525. The printer and scanner communicate via one or more communication channels 530, such as an Ethernet. To provide data from which the tone transfer curve corresponding to the scanner's halftone can be determined, the printer 510 prints at least one patch of half-toned color on a transfer belt (not shown), intermediate belt (not shown) or drum (not shown) associated with the printer 510. A reflectance value measuring device, which may be included in the printer, measures a resultant reflectance value of the half-tone color patch that has been printed upon the transfer belt intermediate belt or drum. A converter converts the resultant reflectance values measured at the reflectance-measuring device into color space estimates. This converter may be implemented in a processor 505 within the scanner.

The scanner 525 adjusts computed color transfer functions by modifying a scanned image in order to compensate for the halftone used to convert the scanned image to a printable form for the printing device 510. As an alternative, the halftone may, itself, be adjusted. A processor 505 in the scanner 525 may perform this adjustment. This adjustment may be performed at a rate approaching the printer speed. A filtering subsystem may be included that sharpens and filters data at a performance level that matches the rest of the pipeline.

According to an exemplary embodiment, an optical sensor may be used as the reflectance-measuring device 515 to measure the resultant reflectance value. The system may further comprise a calibration status-determining device (not shown) used in conjunction with the printing device 510 to indicate whether the printing device 510 is initiating or discontinuing a printer calibration function. Upon the initiation or discontinuation of the printing means calibrating function, the printing device 510 transmits a notification signal to the scanner. The current calibration status of the printing device 510 may also be requested by a status query initiated by the scanner 525. Additionally, the printing device 510 transmits the measured resultant reflectance value to the scanner 525.

The scanner 525 produces a hafltoned image that is suitable for being reproduced at the printing device 510. Also, the printed patch that is printed by the printing device 510 may use a different halftone scheme than the scheme used to halftone the scanned image.

According to an exemplary embodiment, if the printing device 510 does not execute a calibration function upon activation, the scanner 525 will read the measured resultant reflectance value from the last successful printer calibration function. Upon the successful completion of a calibration function by the printing device 510, the scanner 525 will read the measured resultant reflectance value from the completed printer calibration function.

Although a multifunction scanner/printer is described above for illustrative purposes, it should be appreciated that the invention is applicable for delivering image data from any input to any output.

For example, consider a printer using multiple halftone corrections, depending on the data printed. Such a printer may dynamically correct printer halftones for color fidelity, but requires multiple halftone patterns, one for image data, one for textual or line art data, and one for programmed color construction. Consider also that a design requirement for the printer is good performance and availability, but the color measurement for color correction requires considerable time for each halftone. An alternative to measuring each halftone response to generate a correction is to measure one halftone and derive the others. The time to derive additional halftone corrections from the first halftone correction in printer code is negligible compared to the time required to actually measure the response for that halftone. Thus, performance and availability of the printer are enhanced.

Three approaches can be taken to enable this alternative. As a first approach, measurements of all halftones can be made at key points such as cartridge change, elapsed time limit, detected environmental changes, and initial power on and the relationship can be derived for that printer/cartridge combination so that most periodic calibrations need only be done for the most representative halftone. The code to do this measurement, comparison, and derivation may be stored in the printer program space.

Another approach may be a print mechanism model that can be derived such that one halftone's measurements can be used to derive all other halftones based on the model. The equations and algorithms to do this can be stored in the printer's program space.

These two approaches may be applied for deriving different halftones for a printer or for any imaging device, such as a multifunction device as described above.

Similar to the approach described above for a multifunction device, a third approach for deriving printer halftones is to use equations mapping the relationship of various printer halftones that may be empirically derived. Sampling large numbers of printers and cartridges at various stages of cartridge life and environmental conditions provides a fairly robust relationship between the halftone responses. The code to generate the various corrections based on one set of measurements may be stored in the printer's program space.

Other aspects of the invention may be found from the attached drawings and other related materials such as a detailed review of the various functions offered by the present invention, which are integral parts of this disclosure. Moreover, other embodiments of the invention will be apparent to those skilled in the art from consideration of the specification and practice of the invention disclosed herein. It is intended that the specification and examples be considered as exemplary only.

What is claimed is:

1. A method for correcting image data in at least one imaging device, comprising the steps of:
determining a first tone transfer curve corresponding to a first halftone; and
predicting a second tone transfer curve corresponding to a second halftone, based on the determined first tone transfer curve.

2. The method of claim 1, further comprising:
adjusting the image data using the predicted second tone transfer curve; and
halftoning the adjusted image data using the second halftone.

3. The method of claim 1, further comprising:
adjusting the second halftone using the predicted second tone transfer curve; and
halftoning the image data using the adjusted second halftone.

4. The method of claim 1, wherein the tone transfer curves compensate for output variations.

5. The method of claim 1, wherein the step of determining the first tone transfer curve includes measuring image data halftoned with the first halftone and developing a first tone transfer curve that linearizes the measured image data.

6. The method of claim 5, wherein the step of measuring includes measuring image data that is halftoned with the first halftone and printed on a transfer belt, intermediate belt or drum associated with the imaging device.

7. The method of claim 5, wherein the step of predicting a second tone transfer response curve relies on a predetermined relationship between the measured image data that is halftoned with the first halftone and image data that is halftoned with the second halftone.

8. The method of claim 7, wherein the step of predicting a second tone transfer curve comprises:
estimating measured values of image data halftoned with the second halftone, based on the predetermined relationship; and
developing the second transfer curve as the curve that linearizes the estimated measured values of image data halftoned with the second halftone.

9. The method of claim 5, wherein the measuring of image data uses a reflectance sensor.

10. The method of claim 1, wherein the first halftone and the second halftone are applied to account for variations in image data processed by and output from a multifunction device including a first imaging device and a second imaging device.

11. The method of claim 10, further comprising adjusting the image data, using the predicted second tone transfer curve, in the first imaging device.

12. The method of claim 10, wherein the first imaging device is a scanner.

13. The method of claim 10, wherein the second imaging device is a printer.

14. The method of claim 10, wherein the second imaging device is a display.

15. The method of claim 1, wherein the first halftone is a reference halftone, and the second halftone is a halftone selected among multiple halftones for application to the image data.

16. The method of claim 1, wherein the imaging device is a printer, and different halftones are applied for printing different types of data.

17. An apparatus for correcting image data in at least one imaging device, comprising:
means for determining a first tone transfer curve corresponding to a first halftone; and
means for predicting a second tone transfer curve corresponding to a second halftone, based on the determined first tone transfer curve.

18. The apparatus of claim 17, further comprising means for adjusting the image data using the predicted second tone transfer curve, wherein the adjusted image data is halftoned using the second halftone.

19. The apparatus of claim 17, further comprising means for adjusting the second halftone using the predicted second tone transfer curve, wherein the image data is halftoned with the adjusted second halftone.

20. The apparatus of claim 17, wherein the tone transfer curves compensate for output variations.

21. The apparatus of claim 17, wherein the determining means develops a first tone transfer curve that linearizes measured image data halftoned with the first halftone.

22. The apparatus of claim 21, wherein the image data halftoned with the first halftone is measured from image data printed on a transfer belt, intermediate belt or drum.

23. The apparatus of claim 21, wherein the predicting means relies on a predetermined relationship between the measured image data that is halftoned with the first halftone and image data that is halftoned with the second halftone.

24. The apparatus of claim 22, wherein the predicting means estimates measured values of image data halftoned with the second halftone, based on the predetermined relationship, and develops the second transfer curve as the curve that linearizes the estimated measured values of image data halftoned with the second halftone.

25. The apparatus of claim 21, wherein the image data halftoned with the first halftone is measured using a reflectance sensor.

26. The apparatus of claim 17, wherein the first halftone and the second halftone are applied to account for variations in image data processed by and output from a multifunction device including a first imaging device and a second imaging device.

27. The apparatus of claim 26, further comprising means for adjusting the image data using the predicted second tone transfer curve, in the first imaging device.

28. The apparatus of claim 26, wherein the first imaging device is a scanner.

29. The apparatus of claim 26, wherein the second imaging device is a printer.

30. The apparatus of claim 26, wherein the second imaging device is a display.

31. The apparatus of claim 17, wherein the first halftone is a reference halftone, and the second halftone is a halftone selected among multiple halftones for application to the image data.

32. The apparatus of claim 17, wherein the imaging device is a printer, and different halftones are applied for printing different types of data.

33. A system for processing and outputting image data, comprising:
at least one imaging device; and
a device for determining a first tone transfer curve corresponding to a first halftone; and
a device for predicting a second tone transfer curve corresponding to a second halftone, based on the determined first tone transfer curve.

34. The system of claim 33, further comprising a device for adjusting the image data using the predicted second tone transfer curve, wherein the adjusted image data is halftoned using the second halftone.

35. The system of claim 33, further comprising a device for adjusting the second halftone using the predicted second tone transfer curve, wherein the image data is halftoned using the adjusted second halftone.

36. The system of claim 33, wherein the tone transfer curves compensate for output variations.

37. The system of claim 33, further comprising a device for measuring image data halftoned with the first halftone, wherein the determining device develops a first tone transfer curve that linearizes the measured image data halftoned with the first halftone.

38. The system of claim 37, wherein the measuring device measures the image data halftoned with the first halftone from image data printed on a transfer belt, intermediate belt or drum.

39. The system of claim 37, wherein the predicting device relies on a predetermined relationship between the measured image data that is halftoned with the first halftone and image data that is halftoned with the second halftone.

40. The system of claim 39, wherein the predicting device estimates measured values of image data halftoned with the second halftone, based on the predetermined relationship, and develops the second transfer curve as the curve that linearizes the estimated measured values of image data halftoned with the second halftone.

41. The system of claim 37, wherein the measuring device includes a reflectance sensor.

42. The system of claim 33, wherein the imaging device is a multifunction device including a first imaging device and a second imaging device, and the first halftone and the second halftone are applied to account for variations in image data processed by and output from the multifunction device.

43. The system of claim 42, wherein the first imaging device includes a device for adjusting the image data using the predicted second tone transfer curve.

44. The system of claim 42, wherein the first imaging device is a scanner.

45. The system of claim 42, wherein the second imaging device is a printer.

46. The system of claim 42, wherein the second imaging device is a display.

47. The system of claim 33, wherein the first halftone is a reference halftone, and the second halftone is a halftone selected among multiple halftones for application to the image data.

48. The system of claim 33, wherein the imaging device is a printer, and different halftones are applied for printing different types of data.
